(19) United States
(12) Patent Application Publication
(10) Pub. No.: US 2005/0007994 A1
(43) Pub. Date: Jan. 13, 2005

(54) Mobile IP data communication system

(76) Inventors: Shoji Fukuzawa, Kawasaki (JP); Yusuke Takemichi, Yokohama (JP); Hiroshi Tamaribuchi, Yokohama (JP)

Correspondence Address: MCDERMOTT WILL & EMERY LLP, 600 13th Street, N.W., Washington, DC, 20005-3096, US

(21) Appl. No.: 10/871,533

(22) Filed: Jun. 21, 2004

(30) Foreign Application Priority Data
Jun. 23, 2003 (JP) 2003-177452

(51) Int. Cl. H04J 3/24; H04L 12/66; H04L 12/28; H04L 12/56

(52) U.S. Cl. 370/349; 370/352; 370/401

(57) ABSTRACT

A mobile IP data communication system is provided, which is capable of preventing dropouts of packet addressed to the mobile station at the time of switching the packet control station as a result of movement of the mobile station. A packet on an IP data connection that is used by the above-stated mobile station is forwarded to a next packet control station from a previous packet control station of the mobile station. The order of packets is correctly maintained by executing a process that a packet delivered to the next packet control station from the access router while the forwarding is in progress is buffered and a forwarding packet is put through ahead of such buffered packet or is forwarded only up to a time point when a packet from the access router is delivered.

### INCORPORATION BY REFERENCE

This application claims prority based on a Japanese patent application, NO. P2003-177452 filed on Jun. 23, 2003, the entire contents of which are incorporated herein by reference.

### BACKGROUND

The present invention generally relates to an Mobile IP data communication system, and more particularly to a mobile IP data communication system which switches a packet control station relaying an IP data connection from a packet control station to the next packet control station as the mobile station moves.

The second and third generations of mobile telecommunications such as mobile phones are being publicly disseminated. The ratio of IP data communications such as electronic mails and Web accesses is increasing in their use instead of conventional audio telecommunications that had been predominant in the past, and it is anticipated that the IP data communications will become predominant in a few years. Under such circumstances, an economical and high-performance IP data communication system is now desired.

For the third generation of mobile telecommunications, a mobile IP data communication system that is standardized in 3GPP2 (3rd Generation Partnership Project 2) and 3GPP (3rd Generation Partnership Project) has the following features. The system has a mobile station and a base station which directly sends wireless messages to the mobile station and has an access router which mainly sends wired messages to the base station directly or via another device. An IP data connection is established by using a Point-to-Point protocol (PPP: Point to Point Protocol, etc.) which uses such wireless and wired communication paths as a lower layer protocol between the mobile station and the access router. Further, since the access router plays a role of a communication gateway between the mobile station and other networks such as the Internet (hereinafter, referred to simply as the Internet), the mobile station can execute IP data communications by using the IP data connection.

Regular processing to be made as a result of movement of a mobile station is that, while retaining a logical IP data connection between the mobile station and the access router, a device such as a base station which plays the role of the lower layer protocol and relays the IP data connection is switched to the counterparts at the next station. With such arrangement, it is possible for the device that is currently communicating IP data with the mobile station can continue communication without regard to movement of the mobile station. In this connection, it is a packet control station that relays the IP data connection and executes switching of the relaying process between the own device and another device at the time of movement of the mobile station. The packet control station or its functions are stipulated as PCF (Packet Control Function) in 3GPP2, and SGSN (Serving GPRS Support Node) in SGSN, and the mode as an actual device appears in various ways. For example, it may be incorporated in a base station or base station control device, or an access router, or may be an independent device.

Specifications for switching of packet control stations to be occurred as a result of movement of a mobile station are stipulated by A.S0001, A.S0007 and A.S0013 in 3GPP2, and by 3GPP TS 23.060 in 3GPP. In addition, related technologies include those stated in Japanese Patent Publication No. 2002-238067 (herinafter Document 1) and U.S. Pat. No. 6,496,491 (herinafter Document 2).

### SUMMARY OF THE INVENTION

Prior arts have the following problems. That is, in the technologies stipulated by A.S0001, A.S0007 and A.S0013 in 3GPP2 and those stated in Document 2, a packet addressed a mobile station that was delivered via the Internet during a switching processing of packet control stations and forwarded to the previous packet control station is discarded. In addition, with the technologies stated in Document 1, it is necessary to communicate an IP layer between a packet control station and a mobile station, which is not suitable to a packet control station which relays, by using a lower layer protocol, an IP data connection that is terminated between a mobile station and the access router.

The 3GPP TS 23.060 of 3GPP has a packet forwarding mechanism addressed to a mobile station from a previous packet control station to the next packet control station. However, it is based on the premise that a lower layer protocol between the mobile station and the packet control station controls arrival order or resending of packets. In this connection, it is difficult to apply the method to systems that leave resending control of packets to higher application protocols than the IP layer and does not execute resending with lower layer protocols, as represented in A.S0001, A.S0007 and A.S0013 of 3GPP2.

The present invention provides a mobile IP data communication system which can prevent drop-out packets addressed to a mobile station at the time of switching packet control stations as a result of movement of the mobile station also in a system that does not execute resending of packets in lower layer protocols, provided that the mobile station has a function to switch packet control stations. With such arrangement, it is possible to improve communication quality.

The present invention includes a configuration that forwards a packet on an IP data connection used by a mobile station from the previous packet control station to the next packet control station of the mobile station. With the configuration, dropping out of a packet addressed to a mobile station can be prevented when switching packet control stations as a result of movement of a mobile station.

The present invention is configured to incorporate a request for forwarding a packet and a responding message between a current and the next packet control station in a request for switching an IP data connection path which switches packet control stations and responding message thereto. With the configuration, increment in processing time to switch a packet control station caused by an executing packet forwarding process can be prevented.

A packet addressed to a mobile station which is delivered to the access router while the switching process is in progress is forwarded to the previous packet control station. The previous packet control station initiates buffering at timing to receive a switching request and transmit a response for switching so as not to drop out the packet received while the switching process is in progress. The next packet control station which received the response for switching transmits the request for initiating forwarding of the packet received while the switching process is in progress to the previous packet control station. The previous packet control station forwards the buffered packet, and such other packets, if any, that may be received from the access router addressed to the mobile station after completing buffering of packets pursuant to predetermined rules, to the next packet control station.

The next packet control station transmits a request for switching the IP data connection path to the access router almost at the same timing as receiving a response for switching. The access router forwards packets addressed to the mobile station available at a time point after receiving such request and returning a response thereto. Consequently, the packets that are forwarded to the next packet control station from the access router via the next packet control station during the switching process should be those that were forwarded at times earlier than packets forwarded by the access router after the switching. Therefore, when transmitting the packets received to the mobile station, the next packet control station transmits the packets forwarded from the previous packet control station ahead of the packets received from the access router. With such arrangement, it is possible to prevent order change of packets.

In order to prevent order change of old and new packets, the next packet control station can, for example, set a forwarding-wait timer for a certain period of time to buffer received packets delivered by the access router before the timer is up, and transmit the forwarding packets first to the mobile station. Alternatively, sending of forwarded packets to the mobile station may be carried out only during the time period up until the first packet following the switching from the access router is delivered, and thereafter, packets received from the access router are transmitted to the mobile station and the forwarding packet can be discarded even if they are delivered. It is effective to set the timer period as longer as possible by using the former method to prevent dropping out of packets. However, the latter method is effective to abridge the communication shutdown period for packets on the IP data connection as a result of the switching processing. Thus, either method can be selected to satisfy the policy of the system operator, or to choose the one that ensures best performance for the system.

It is necessary for the next mobile station and the previous packet control station to know mutual IP addresses to execute forwarding, receiving, etc. of a request for switching IP data connection path or a responding message thereto by using an IP packet. Therefore, it is not necessary to exchange the IP addresses exclusive for packet forwarding anew if the same IP addresses are used for a packet forwarding process. However, in terms of the fact that a packet control station is a device to execute relaying of many user traffics, the station is sometimes realized as a device that combines a plurality of devices having different IP addresses to share loads or for redundant configuration. In such a case, it is necessary for the source and the destination packet control station for transmission should mutually know IP addresses used for actual packet forwarding, in addition to a typical IP address used for transmitting and receiving a request for switching and a response. A method to realize this is that transmission is carried out by including the destination and source IP addresses for forwarding respectively in the request message for switching IP data connection path and packet forwarding, and the responding message thereto.

Identifier key information may be included in a forwarding packet to transmit/receive the forwarding packet between packet control stations and associate the forwarding packet with the IP data connection and a mobile station. For the identifier key, there is a method to use an IP data connection or identification information of a mobile station itself. Since such information is usually required for a process to switch IP data connection paths, it is not necessary to exchange the identification key information exclusive for packet forwarding between the source and the destination packet control stations for forwarding. Alternatively, the identifier key information exclusive for packet forwarding may be included in either one or both of a request for switching IP data connection paths and packet forwarding, and a responding message thereto. When this method is used, it is possible to use any identifier key.

In a process to switch IP data connection paths, there may be a case where switching of wireless paths and wired paths are executed at concurrent timing depending on purposes such as to abridge switching time of the entire path. In such a case, even if switching of wired path is completed and a packet addressed to a mobile station from the access router starts arriving at the next packet control station, the next packet control station may buffer the delivered packet up until the switching of wireless path is completed when the switching of wireless path is in progress. Under such status, such packet that is forwarded from the previous packet control station under the method as provided in a preferred embodiment of the present invention is also buffered in the next packet control station.

For the method in which a packet from the access router is buffered by using a forwarding timer, another buffer different from the buffer for a forwarding packet from previous packet control station may be used. Under status where the two different buffers are used, when a packet transmitted to a mobile station upon completion of switching to the wireless path, etc., a buffered forwarding packet in the buffer will be transmitted to the mobile station if the transmission is made before the forwarding timer is up. Further, for a case where, under the status that the two different buffers are used, the forwarding timer is up, the two buffers are integrated to one buffer so that the transmission is carried out to the mobile station in the order of the forwarding packet and the packet from the access router, including the case that either one or both of the two buffers are empty. Transmission to the mobile station after the buffer integration is carried out in the order of packets available in the buffer, and when a packet from the access router is buffered, the packet is added to the buffer end so that the transmission order to the mobile station can be last.

On the other hand, in such a case where acceptance of packet forwarding is limited up until the first arrival of a packet from the access router to the next packet control station after the switching of the IP data connection paths and subsequent forwarding packets are discarded, buffering may be carried out, unlike the above-stated method, for only one buffer from the beginning. In this case, ordinality of packets can be correctly maintained by buffering packets from the access router subsequent to buffering of the last forwarding packet.

According to the present invention, it is possible to prevent dropouts of packet addressed to a mobile station at the time of switching packet control stations as a result of movement of the mobile station, thus enabling improvement in telecommunication quality.

These and other benefits are described throughout the present specification. A further understanding of the nature and advantages of the invention may be realized by reference to the remaining portions of the specification and attached drawings.

### BRIEF DESCRIPTION OF THE DRAWINGS

FIG. 1 is a sequence diagram showing processing procedures according to an embodiment.

FIG. 2 is a block diagram showing a configuration of a mobile IP data communication system according to the embodiment.

FIG. 3 is a sequence diagram showing processing procedures of a previous packet control station according to the embodiment.

FIG. 4 is a sequence diagram showing processing procedures of a next packet control station according to the embodiment.

FIG. 5 is a sequence diagram showing forwarding and buffering processes among the processing procedures of the next packet control station according to the embodiment.

FIG. 6 is a diagram showing a packet flow under a first status among packet flows in which the application of the embodiment works effectively.

FIG. 7 is a diagram showing a packet flow under a second status among packet flows in which the application of the embodiment works effectively.

FIG. 8 is a diagram showing a packet flow under a third status among packet flows in which the application of the embodiment works effectively.

FIG. 9 is a diagram showing a packet flow under a fourth status among packet flows in which the application of the embodiment works effectively.

FIG. 10 is a diagram showing a packet flow under a fifth status among packet flows in which the application of the embodiment works effectively.

### DETAILED DESCRIPTION OF THE EMBODIMENTS

Hereinafter, a preferred embodiment of the present invention will be described.

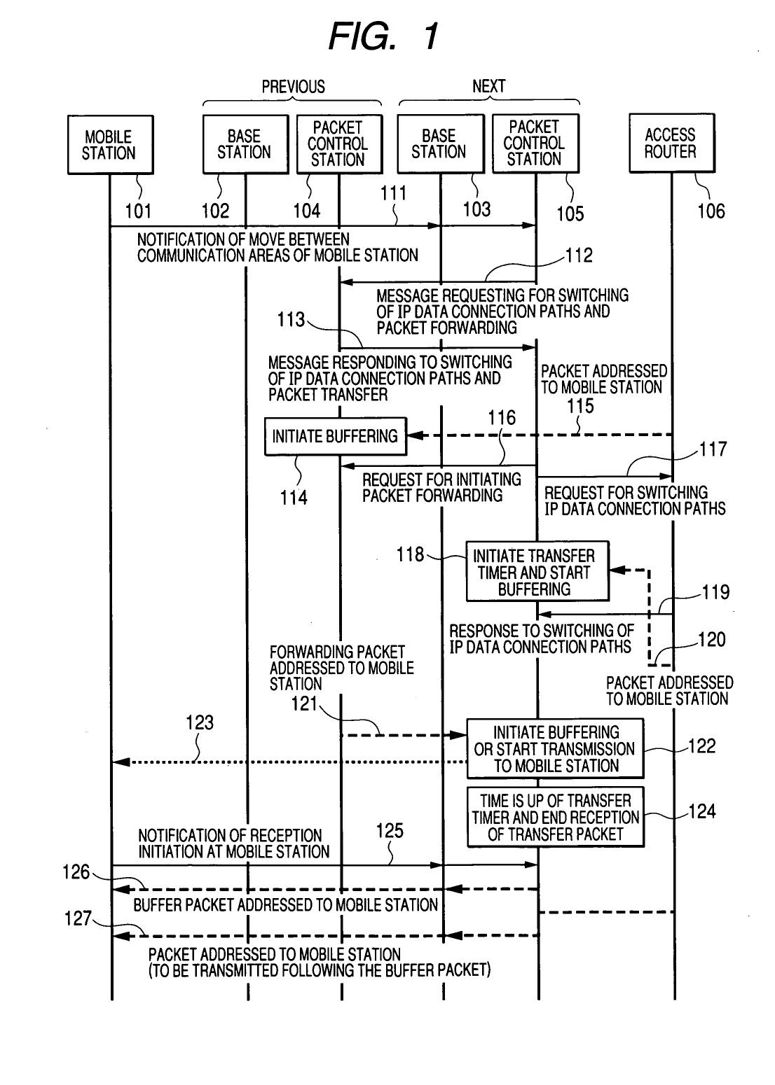

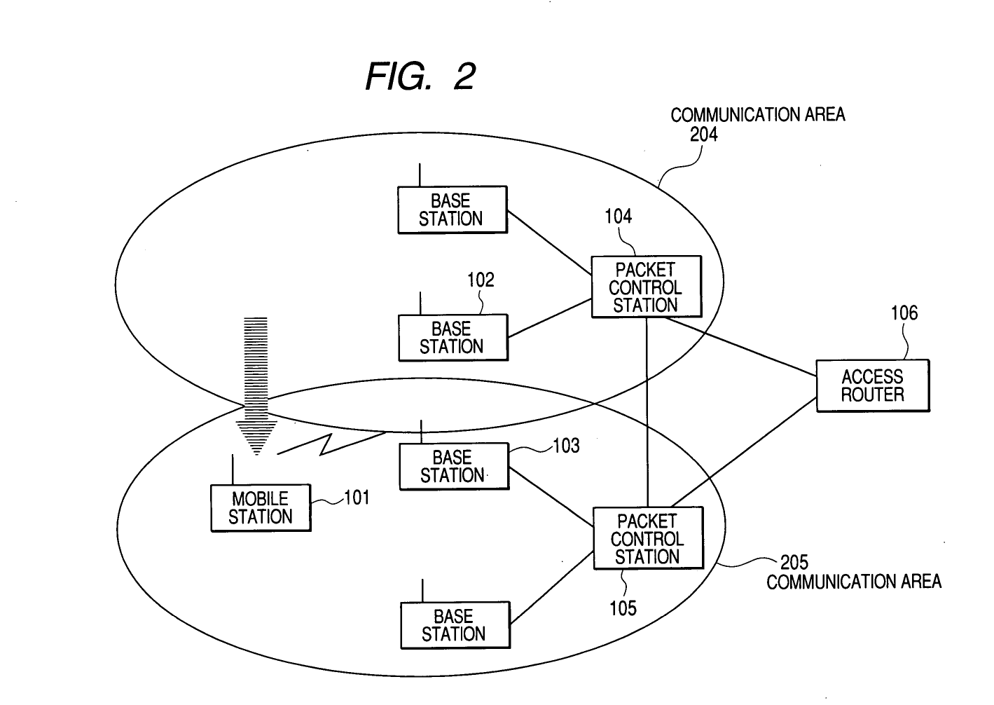

FIG. 1 is a sequence showing processing procedures of a mobile IP data communication system according to the embodiment. This system includes a mobile station device (hereinafter referred to as a mobile station), a base station device (hereinafter referred to as a base station), a packet control station device (hereinafter referred to as a packet control station) and an access router device (hereinafter referred to as an access router). In this system, a packet control station is connected to a plurality of base stations which executes wireless telecommunications with a mobile station. In addition, an aggregate of a wireless telecommunications area covered by such base stations is designated to be a communication area associating with the packet control station. FIG. 2 is a block diagram showing a configuration of the above-stated mobile IP data communication system.

Each of the above-stated devices is provided with at least a CPU and a memory and realizes processes described below in line with a flow chart on each device as the CPU executes programs stored in the memory. Further, each program may be stored in advance in the memory of each device, or may be introduced, as required, from other devices that are usable by the devices concerned via a detachable storage medium, a communication medium network or a carrier wave propagating on the network.

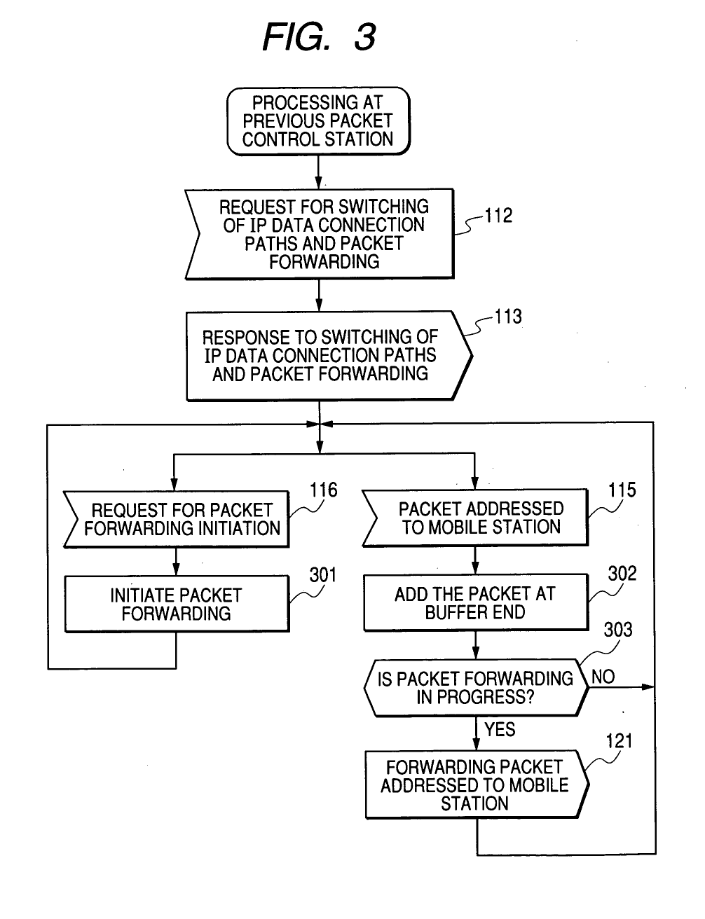

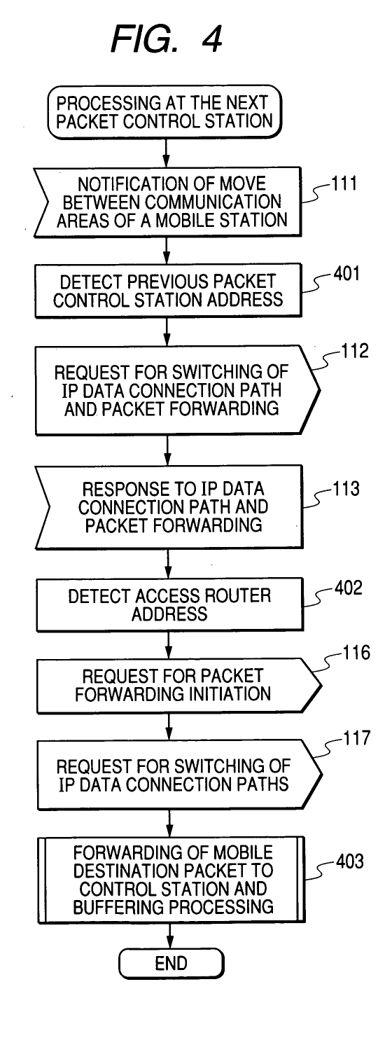

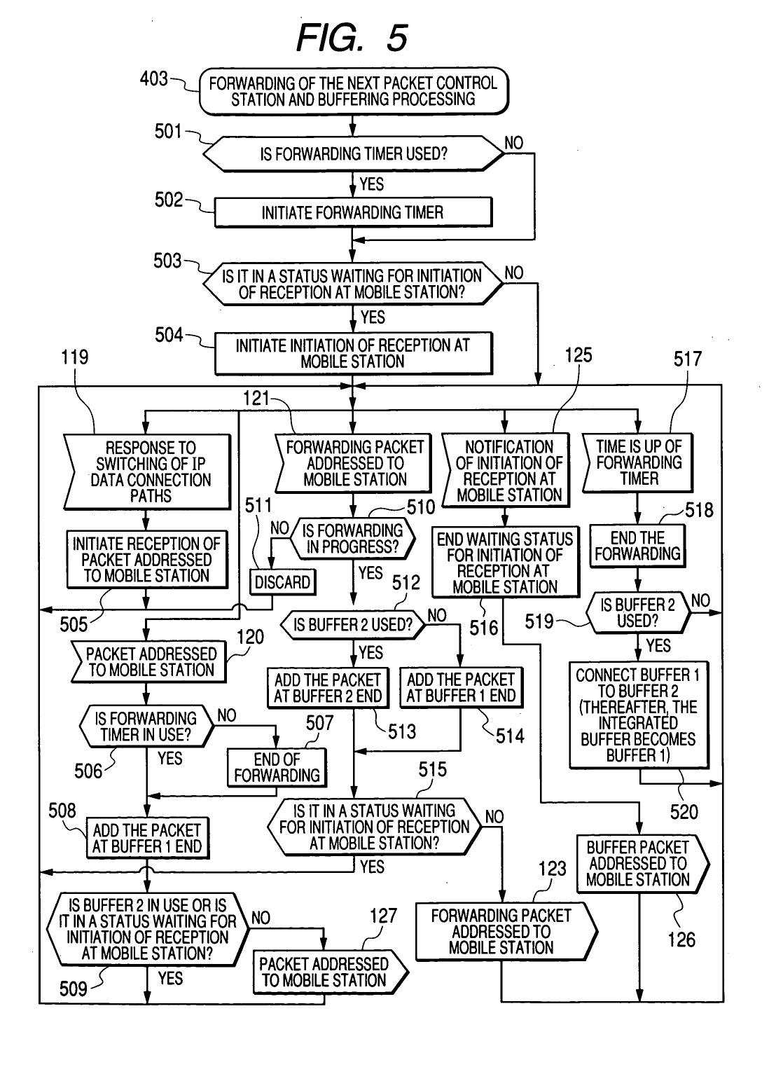

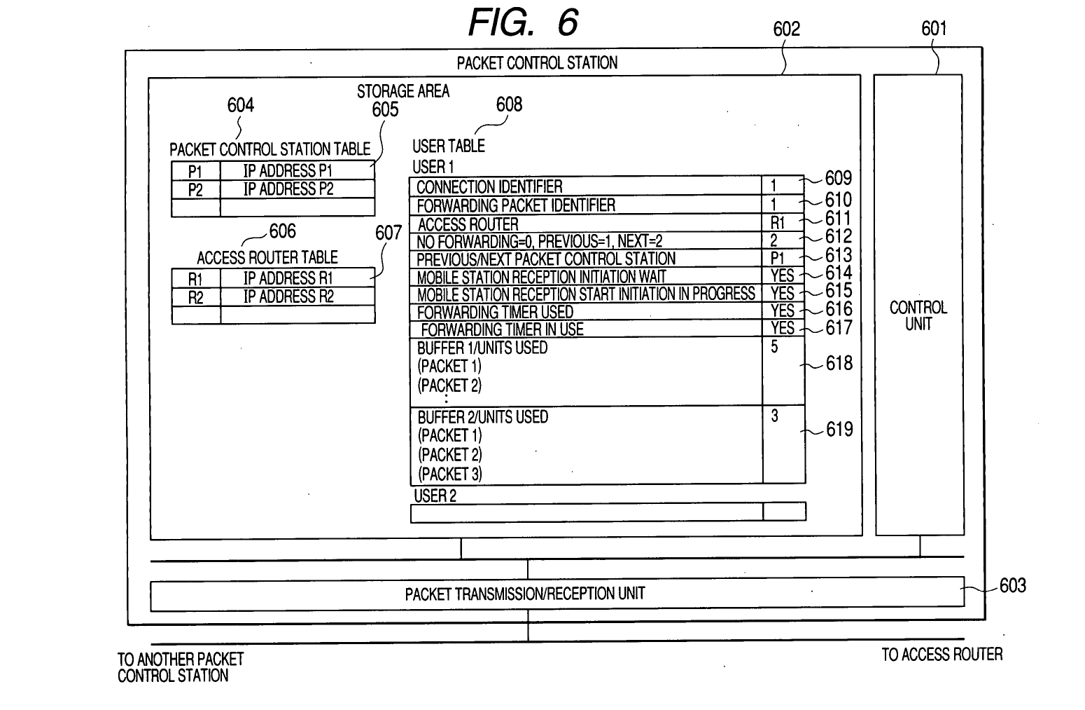

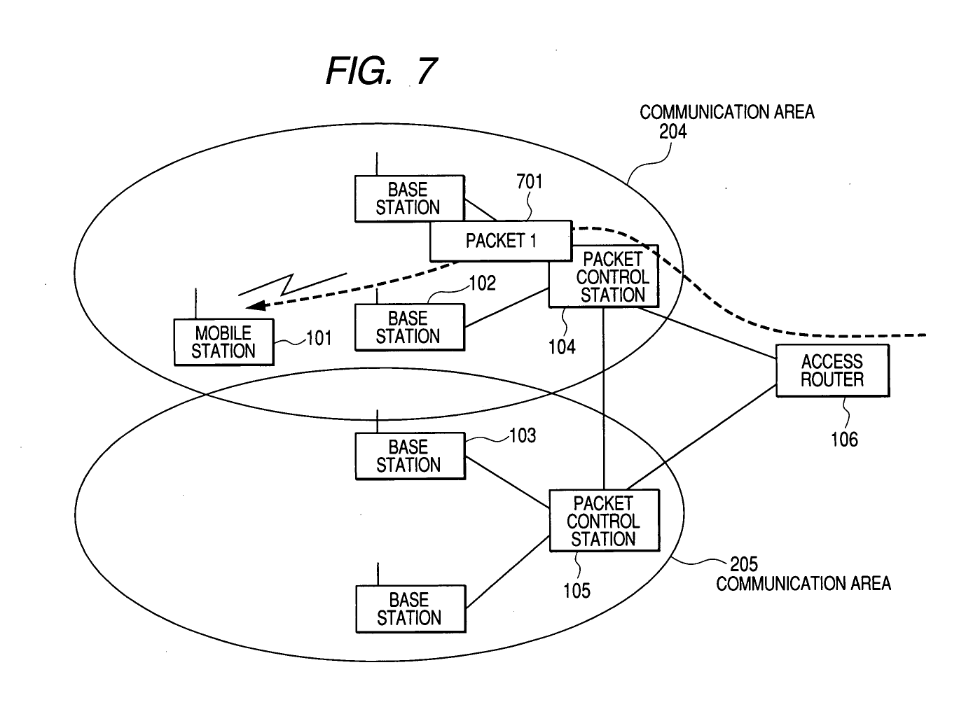

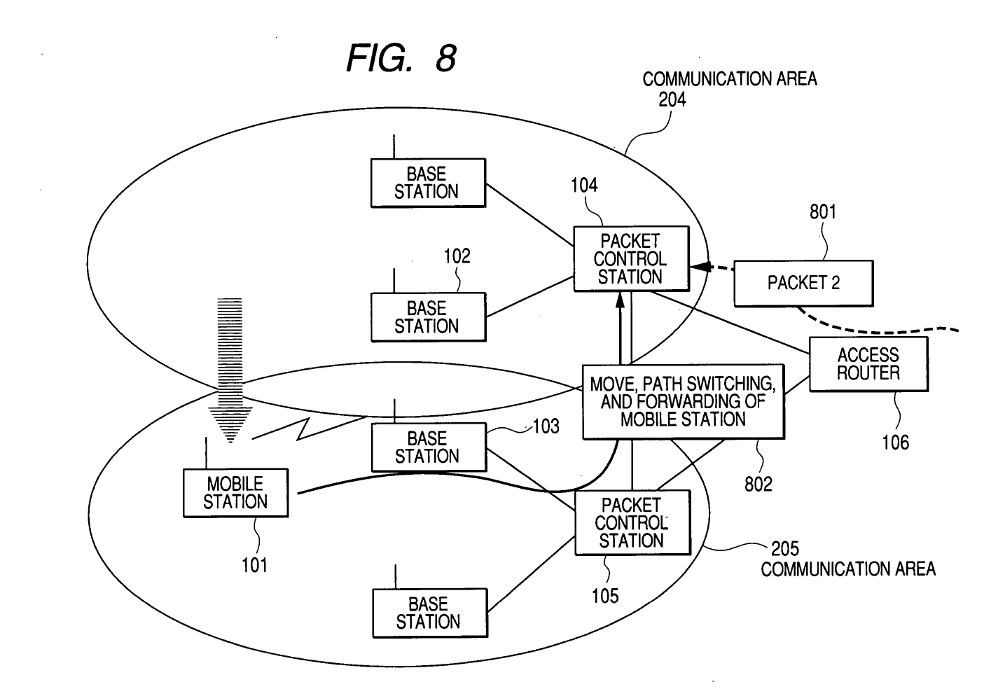

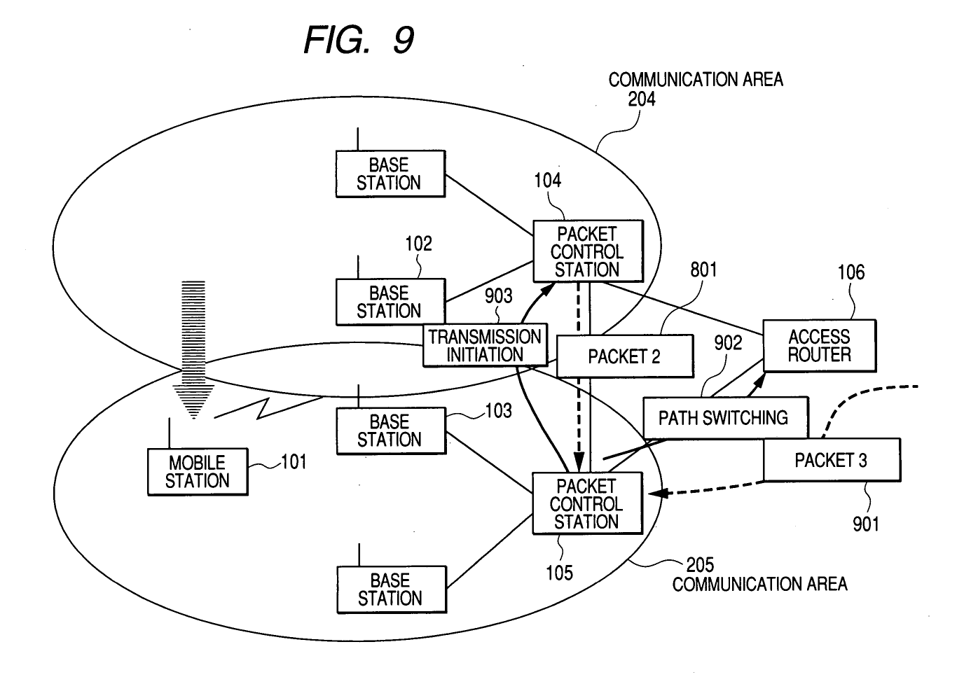

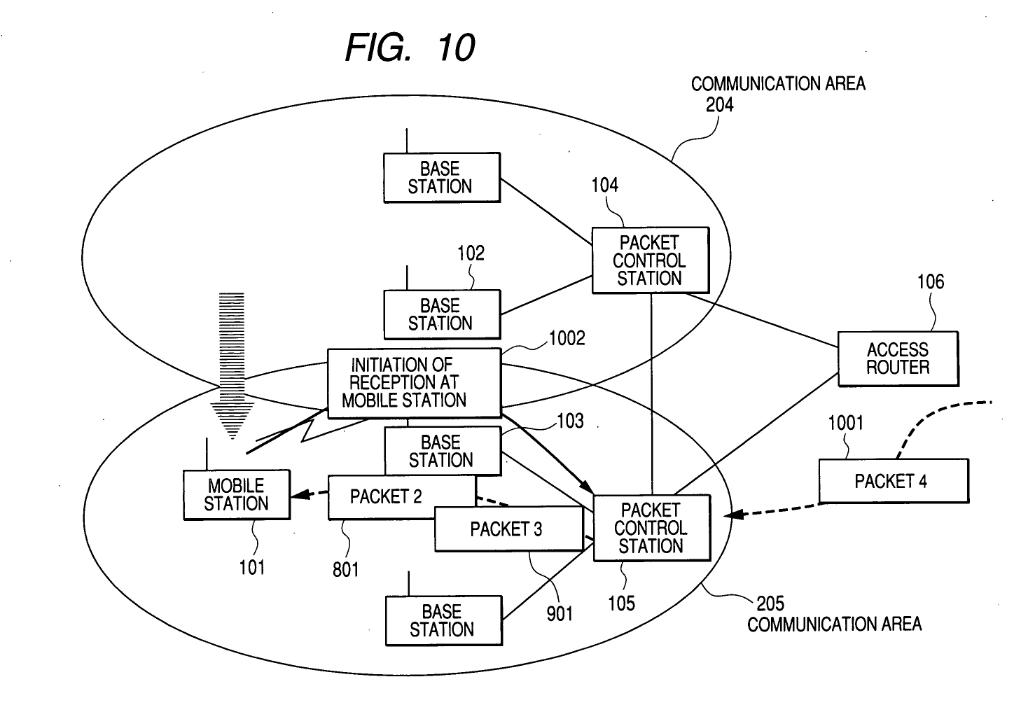

Further, FIG. 3 is a flow chart showing processes of a previous packet control station which is associated with the sequence processes shown in FIG. 1, and likewise, FIG. 4 is a flow chart showing processes of another previous packet control station. FIG. 5 is a flow chart showing processes that are associated with forwarding and buffering processes in the processes shown in FIG. 4. FIG. 6 is a configuration diagram of a packet control station according to the embodiment. FIGS. 7, 8, 9 and 10 show that packet flows in which application of the embodiment works effectively are overlapped with the system block diagram shown in FIG. 2.

Hereinafter, processes on the flow charts in FIGS. 2, 3 and 4 that are associated with the sequence shown in FIG. 1 will be described, and further, operations at respective parts of the configuration diagram in FIG. 6 will also be described. Thereafter, by using FIGS. 7, 8, 9 and 10, how the embodiment affects the flows of packets will be described.

A mobile station 101 and a next base station 103, as the mobile station 101 shown in FIG. 2 moves, shift the status in which the mobile station 101 communicates with a current base station 102 connected to a previous packet control station 104 to that in which the mobile station 101 communicates with a next base station 103 connected to a next packet control station 105. Accordingly, the mobile station 101 and the next base station 103, upon detecting the shift from a communication area 204 associating with the previous packet control station 104 to a communication area 205 associating with the next packet control station 105, transmits a notification message of move between communication areas of mobile station 111 to the next packet control station 105 (Step 111).

Upon receiving the message, the next packet control station 105 executes the processes that a control unit 601 executes transmission and reception of a message and/or a packet via a packet transmission/reception unit 603 and refers to and updates respective tables available in a storage area 602. The previous packet control station 104 provides similar processes.

The next packet control station 105 creates an entry for User 1 on a user table 608 based on the content of message received. Here, a connection identifier 609 shall be a value contained in the received message and forwarding status 612 shall be a value indicating the next packet control station. The previous packet control station address is detected here. The received message may sometimes contain the previous packet control station address, or may contain a packet control station identifier. If the packet control station identifier is contained, it is registered with a previous/next packet control station 613, and an address 605 is detected out of values that are preset in a packet control station table 604 (Step 401). A mobile station reception initiation wait 614 will be set according to the system configuration, and a forwarding timer used 616 will be set according to the system or the device configuration.

The next packet control station 105 transmits a massage requesting for switching of IP data connection path and packet forwarding 112 to the address of the previous packet control station 104 thus detected (Step 112). The connection identifier 609 shall be included in the message so that the previous packet control station 104 can discriminate a target for switching.

When a voluntary value is used for the forwarding packet identifier, a forwarding packet identifier 610 shall be configured and included in the message. For a system configuration where, for example, it is predetermined that the same value as the connection identifier is used for the forwarding packet identifier, the forwarding packet identifier 610 may not be included in the message.

Additionally, unlike the embodiment, there may be a case where an IP address for transmission and reception of the message or a message responding to switching of IP data connection paths and packet forwarding 113 is different from an IP address for packet forwarding. In such a case, an IP address for packet forwarding or a packet control station identifier is included in the message and the message responding to switching of IP data connection paths and packet forwarding 113, and the previous packet control station 104 and the next packet control station 105 mutually record an IP address for forwarding received from the other packet control station in entries of the user table 608.

The previous packet control station 104 sets a value indicating the destination for forwarding for the forwarding status 612 of an entry on the user table 608 associating with the connection identifier contained in the message received, and configures an identifier for the next packet control station 105 in the current/next packet control stations 613. In addition, if a forwarding packet identifier is included in the message received, the forwarding status 612 is configured to the forwarding packet identifier 610.

The previous packet control station 104 transmits the message responding to switching of IP data connection paths and packet forwarding 113 to the next packet control station 105 (Step 113) and initiates buffering simultaneously (Step 114). Details of the buffering initiation processes will be described later.

The next packet control station 105 detects an access router address (Step 402). Here, an access router identifier contained in the message received is configured as an access router 611 of the user table 608. Further, the next packet control station 105 detects an address 607 out of the access router identifier received, by referring to a value preset in an access router table 606. The access router address may be directly included in the message received, or alternatively, an access router that associates with a mobile station, user or a packet control station may be determined in advance.

The next packet control station 105 transmits a request for initiating packet forwarding 116 to the previous packet control station 104 (Step 116), and transmits a request for switching IP data connection paths 117 to the access router 106 (Step 117). As regards processes to be executed thereafter including initiation of forwarding timer and buffering (Step 118), buffering or initiation of transmission to a mobile station (Step 122), and time up of forwarding timer and termination of forwarding packet reception (Step 123) as well as transmission and reception of various messages and packets, they will be described in the paragraph of forwarding of the next packet control station and buffering processes (Step 403).

Details of the initiation of buffering process (Step 114) in the previous packet control station 104 stated in the above will be described hereunder. The previous packet control station 104 which received the request for initiating packet forwarding 116 is put in the packet forwarding initiation status (Step 301). On the other hand, when receiving a packet addressed to mobile station 115 from the access router, the station 104 adds the packet at the end of a buffer 618 and updates the number of packets used (Step 302). Here, if the packet forwarding initiation status stated in the above has been established, then the process goes to the next step. If the status has not been established, the packet remains in the buffered status (Step 303). Packets that are kept buffered for a specified period of time or over will be discarded, which is the common processing for the source and destination packet control stations for forwarding in terms of buffering processing. Further, even for a case where the total number of buffers is limited or the total number of packets used for each user is limited, processes that packets are discarded starting from older packets available in the buffer of all users for the case of the total number, or of applicable users for the case of the number of packets used for each user, for example. If it is in the status that the packet forwarding has been initiated, part of or all packets in the buffer will be transmitted sequentially starting from the packet at the top of the buffer to the next packet control station as a forwarding packet addressed to mobile station 121 (Step 121).

Next, detailed processes of the next packet control station forwarding and buffering (Step 403) will be described.

First, setup of the forwarding timer used 616 is checked (Step 501). If it is set to YES, then the forwarding timer is initiated, and, simultaneously, a forwarding time in use 617 is set to YES (Step 502). Subsequently, setup of the mobile station reception initiation wait 614 is checked (Step 503). If it is set to YES, then the mobile station reception initiation wait in progress 615 is set to YES (Step 504).

When the forwarding packet addressed to mobile station 121 is received from the previous packet control station 104 (Step 121), a check is made as to whether the packet forwarding is in progress (Step 501). For a case that the packet forwarding is not in progress because the forwarding has been completed, for example, the packet received is discarded (Step 511). In other cases, a check is made as to whether a buffer 2 (619) is in use (Step 512). The buffer 2 (619) becomes in-use status when the mobile station reception initiation wait 614 is set to YES and the forwarding time in use 617 is set to YES.

If the buffer 2 (619) is in the in-use status, the packet is added to the end of the buffer 2 (619) (Step 513), or if it is in other status, the packet is added to the end of a buffer 1 (618) (Step 514). Then, a check is made as to whether the mobile station reception initiation wait in progress 615 is set to YES (Step 515). If it is set to YES, the packet is kept buffered. If it is set to NO, the packet is transmitted as a forwarding packet addressed to mobile station 123 (Step 123).

On the other hand, for reception from the access router 106, a response to switching of IP data connection paths 119 is first received (Step 119) to establish a packet addressed to mobile station reception initiation status (Step 505). Thereafter, a packet addressed to mobile station 120 is received (Step 120), the forwarding time in use 617 is checked (Step 506).

In a case where no forwarding timer is used, the forwarding status 612 is set to a value representing no forwarding when the first packet addressed to mobile station 120 from the access router is received, and the forwarding is terminated (Step 507). A received packet is added to the end of the buffer 1 (618) (Step 508). When the buffer 2 (619) is in use or the mobile station reception initiation wait in progress 615 is set to YES, no transmission is possible from the buffer 1 (618) to a mobile station (Step 509). In other cases, part of or all packets available in the buffer 1 (618) are transmitted as a packet addressed to mobile station 127 (Step 127).

When the mobile station reception initiation wait in progress 615 is set to YES and a notification of initiation of reception at mobile station 125 is received (Step 125), the mobile station reception initiation wait in progress 615 is set to NO and the mobile station reception initiation wait is terminated (Step 516). If any packet under buffering status is available, part or all of such packets are transmitted as a buffer packet addressed to mobile station 126 (Step 126). However, at this time, if the buffer 2 (619) is in use, no packets in the buffer 1 (618) cannot be transmitted.

When the forwarding time in use 617 is set to YES and the forwarding timer is up (Step 517), the forwarding status 612 is set to a value representing no forwarding and the forwarding is terminated (Step 518). At this time, a check is made as to whether the buffer 2 (619) is in use (Step 519). If the buffer 2 (619) is set to YES, both of the buffer 1 (618) and the buffer 2 (619) are integrated to be regarded as the buffer 1 (618) by coupling the buffer 1 (618) to the end of the buffer 2 (619), and the use of the buffer 2 (619) is terminated (Step 520).

The processes in the embodiment are described above, and with such processes, the flows of a packet before and after switching of IP data connection paths will be as below.

First, a packet 1 (701) addressed to the mobile station 101 made available before the mobile station 101 moves is delivered to the mobile station 101 via the previous packet control station 104 and the base station 102.

Next, as the mobile station 101 moves, path switching and forwarding processes 802 are carried out among the next base station 103, packet control station 105 and previous packet control station 104. Since path switching is not yet carried out at the access router at this time, a packet 2 (801) addressed to the mobile station 101 is delivered to the previous packet control station 104. The previous packet control station buffers the packet 2 (801).

Subsequently, when path switching process 902 to the access router 106 and forwarding initiation process to the previous packet control station 104 are executed almost at the same time, a switching process is executed at the access router 106. A packet 3 (901) addressed to the mobile station 101 that is delivered thereafter will be forwarded to the next packet control station 105. In addition, the packet 2 (801) that was kept buffered at the previous packet control station will also be forwarded to the next packet control station 105.

The packet addressed to the mobile station 101 is forwarded to the previous packet control station 104 before the switching process of the access router 106 is completed, or to the next packet control station 105 after the switching process is completed. In this connection, it is mandatory, in the next packet control station 105, that the forwarding packet should be sent to the mobile station earlier than the packet from the access router 106. To realize this arrangement, a forwarding timer is used to maintain a correct order by storing the packet 2 (801) in the buffer 2 and the packet 3 (901) in the buffer 1 when the mobile station reception initiation wait process is executed. Thus, it is possible to ensure to keep the transmission of the packet 2 (801), the packet 3 (901) and a packet 4 (1001) which is delivered thereafter in this order to the mobile station, irrespective of the timing that the forwarding timer is up or the notification of reception initiation at mobile station is issued, whichever comes first.

As described in the above, according to the embodiment, it is possible to prevent a dropout of packet addressed to mobile station at the time of switching the packet control stations that occurs as a result of movement of a mobile station, if the mobile station is provided with a function to switch packet control stations.

In addition, with the embodiment, it is possible to voluntarily set a forwarding timer used itself and the timer value thereof in a next packet control station. As a result, while a logical IP data connection between a mobile station and an access router is retained, when the relaying device associating with lower layer protocols thereof is switched to the next relaying device, it is possible to provide a mobile IP data communication system wherein the measures for preventing dropouts of packet at the time of switching are dependent on a resending mechanism of upper application layer protocols, etc. with a function to prevent dropouts of packet at the time of the switching which does not require any special equipment and is capable of suppressing effects of changes.

The specification and drawings are, accordingly, to be regarded in an illustrative rather than a restrictive sense. It will, however, be evident that various modifications and changes may be made thereto without departing from the sprit and scope for the invention as set forth in the claims.

1. A mobile IP data communication system comprising:
a mobile station;
a plurality of packet control stations; and
an access router;
wherein
the mobile station establishes an IP data connection to be relayed by a packet control station with the access router and, when the mobile station moves from a communication area associated with one of the packet control stations to the next communication area associated with the next one of the packet control stations, the mobile station switches the packet control station relaying the IP data connection to the next packet control station from the previous packet control station; and wherein
the next packet control station includes a unit for transmitting to the previous packet control station a message requesting for switching of a IP data connection path and packet forwarding including information that can identify the IP data connection;
the previous packet control stations includes a unit for transmitting a message requesting for switching of the IP data connection path and packet forwarding including information required for the switching of the IP data connection to the next packet control stations, and for initiating buffering of a packet received from the access router on the IP data connection;
the next packet control station includes a unit for transmitting a message requesting for initiating forwarding of a packet to be received from the access router to the previous packet control station, and a unit for transmitting to the access router a message requesting for switching of the IP data connection path including information that can identify the IP data connection;
the previous packet control station includes a unit for forwarding the buffered reception packet to the next packet control station and then forwarding a packet on the IP data connection received from the access router following the buffered packet received to the next packet control station;
the access router includes a unit for switching the packet control station relaying the IP data connection to the next packet control station from the previous packet control station and transmitting a responding message to switch the IP data connection path to the next packet control station; and
the next packet control station includes a packet-order-change-preventing unit for forwarding a packet forwarded from the previous packet control station ahead of a packet received from the access router.

2. The mobile IP data communication system according to claim 1, wherein
the next packet control station includes a unit for transmitting to the access router a message requesting for switching of the IP data connection path including information that can identify the IP data connection and initiating a packet forwarding timer on the IP data connection between the previous and next control stations; and
the packet-order-change-preventing unit of the next packet control station includes a unit for buffering the packet on the IP data connection received from the access router before the forwarding timer is up.

3. The mobile IP data communication system according to claim 1, wherein
the packet-order-change-preventing unit of the next packet control station includes a unit for discarding a packet that is forwarded from the previous packet control station after receiving the packet on the IP data connection for the first time from the access router.

4. The mobile IP data communication system according to claim 1, wherein
the message requesting for switching of the IP data connection path and packet forwarding that are transmitted by the next packet control station to the previous packet control station includes information on destination IP address for forwarding of the packet on the IP data connection to be forwarded to the previous packet control station from the next packet control station; and
the message responding to switching of the IP data connection path and packet forwarding that are transmitted by the previous packet control station to the next packet control station includes information on source IP address for forwarding of the packet on the IP data connection to be forwarded to the next packet control station from the previous packet control station.

5. The mobile IP data communication system according to claim 1, wherein
the packet on the IP data connection includes identification information that indicates the IP data connection, the mobile station, or a user of the mobile station as identifier key information to be forwarded to the next packet control station from the previous packet station.

6. The mobile IP data communication system according to claim 1, wherein
at least one of the message requesting for switching of the IP data connection path and packet forwarding that are transmitted by the next packet control station to the previous packet control station and the message responding to switching of the IP data connection path and packet forwarding that are transmitted by the previous packet control station to the next packet control station includes identifier key information to be included in the packet of the IP data connection to be forwarded by the previous packet control station to the next packet control station.

7. The mobile IP data communication system according to claim 2, wherein
the next packet control station includes:
a unit for buffering the packet on the IP data connection that is forwarded from the previous packet control station;
a unit for transmitting a buffered packet in a buffer that is forwarded by the previous packet control station, when transmitting the packet on the IP data connection to a side of the mobile station before the forwarding timer is up; and
a unit, when the forwarding timer is up, for combining the buffered packet in the buffer that is forwarded by the previous packet control station and the buffered packet in the buffer that is received from the access router into one buffer so that transmission order to the mobile station can be in this order.

8. The mobile IP data communication system according to claim 1, wherein
the next packet control station includes:
a unit for buffering the packet on the IP data connection that is forwarded by the previous packet control station; and
a unit for buffering the packet on the IP data connection received from the access router subsequent to the buffer in which the packet forwarded by the previous packet control station is buffered.
